(19) United States
(12) Patent Application Publication
(10) Pub. No.: US 2003/0027459 A1
(43) Pub. Date: Feb. 6, 2003

(54) Power supply apparatus having protection structure for plug

(75) Inventor: Tseng-Fu Lee, Taoyuan Shien (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Delta Electronics Inc., Taoyuan Shien (TW)

(21) Appl. No.: 09/965,476

(22) Filed: Sep. 27, 2001

(30) Foreign Application Priority Data
Aug. 6, 2001 (TW) 090213333

(51) Int. Cl. H01R 13/04

(52) U.S. Cl. 439/693

(57) ABSTRACT

A power supply apparatus having a protection structure for a plug is disclosed. The power supply apparatus includes a case and the plug comprising at least two conductive terminals. The power supply apparatus is characterized in that the powder supply apparatus further includes at least two insulating rings corresponding to the conductive terminals, wherein each insulating ring has a particular length, is surrounded each conductive terminal and is connected to a junction area of the case and each conductive terminal.

### FIELD OF THE INVENTION

The present invention relates to a power supply apparatus, and more particularly to a power supply apparatus having a protection structure for plug.

### BACKGROUND OF THE INVENTION

The power supply apparatus principally includes an insulating case, a plug and a circuit board. The plug is used for connecting the external power source passed into the internal circuit. The function of the internal circuit in a connector, such as an adapter or a charger, is used for rectifying and transforming the power source into the direct current employed by the electronic equipment or the chargeable battery. Typically, the plug of the power supply includes two metal pins used for plugging into a wall socket to receive the commercial power source.

FIG. 1 is a diagram illustrating a plug of a power supply apparatus inserted into a wall socket according to the prior art. As shown in FIG. 1, when the plug is plugged into the wall socket 11, a portion of metal pin 102 between a case 10 and the socket 11 could be exposed due to improper design of the socket or half-inserted by user's carelessness. Therefore, the following safety problems will happen:

1. Children could use their fingers to touch the exposed portion of the metal pin and get the electric shock.

2. If the power supply apparatus is used in a high moisture environment such as bathroom, once the water is dropped to the exposed portion of the metal pin, a short circuit could happen and even cause an electric fire.

3. If the power supply apparatus is used in a moisture and dust environment, the dust could accumulate between two metal pins to decrease the distance therebetween. Hence, once ionization occurs, it also could cause an electric fire.

Therefore, the purpose of the present invention is to develop a power supply apparatus having a protection structure for a plug to deal with the above situations encountered in the prior art.

### SUMMARY OF THE INVENTION

It is therefore an object of the present invention to provide a power supply apparatus having a protection structure for a plug for preventing the electric fire from happening.

It is therefore another object of the present invention to provide a power supply apparatus having a protection structure for a plug for preventing the user from getting an electric shock when improperly using the plug such as half-inserted.

According to an aspect of the present invention, there is provided a power supply apparatus having a protection structure for a plug comprising a case and the plug comprising at least two conductive terminals. The power supply apparatus is characterized in that the powder supply apparatus further comprises at least two insulating rings corresponding to the conductive terminals, wherein each insulating ring having a particular length, is surrounded each conductive terminal and is connected to a junction area of the case and each conductive terminal.

For example, the power supply apparatus is an adapter or a charger.

Preferably, the insulating rings and the case are made of a thermal plasticity material. For example, the thermal plasticity material is polycarbonate (PC) resin, poly-phenylene oxide (PPO) resin, nylon, polybutylene terephthalate (PBT) resin, acrylonitrile-butadiene-styrene (ABS) resin, or a combination thereof.

Preferably, the particular length is ranged from 3 to 5 mm.

Preferably, each conductive terminal has two gaps located at the junction area for fastening each the conductive terminal on the case.

Preferably, the insulating rings and the case are integrally formed.

According to another aspect of the present invention, there is provided a power supply apparatus having a protection structure. The power supply apparatus includes a plug comprising at least two conductive terminals, a case having at least two holes for the at least two conductive terminals inserting therein, at least two insulating rings corresponding to the conductive terminals, wherein each insulating ring has a particular length, is surrounded each conductive terminal at a root section and is connected to a junction area of the case and each conductive terminal.

For example, the power supply apparatus is an adapter or a charger.

Preferably, the insulating rings and the case are made of a thermal plasticity material. For example, the thermal plasticity material is polycarbonate (PC) resin, poly-phenylene oxide (PPO) resin, nylon, polybutylene terephthalate (PBT) resin, acrylonitrile-butadiene-styrene (ABS) resin, or a combination thereof.

Preferably, the particular length is ranged from 3 to 5 mm.

Preferably, each conductive terminal has two gaps located at the junction area for fastening each conductive terminal on the case.

Preferably, the insulating rings and the case are integrally formed.

The present invention may best be understood through the following description with reference to the accompanying drawings, in which:

### BRIEF DESCRIPTION OF THE DRAWINGS

FIG. 1 is a diagram illustrating a plug of a power supply apparatus inserted into a wall socket according to the prior art;

FIG. 2 is a three-dimensional view illustrating a preferred embodiment of a power supply apparatus having a protection structure for a plug according to the present invention;

FIGS. 3A-3C are diagrams illustrating a preferred embodiment of a method for producing a protection structure applied in a power supply apparatus according to the present invention; and

FIG. 4 is a decomposed diagram illustrating another preferred embodiment of a power supply apparatus having a protection structure for a plug according to the present invention.

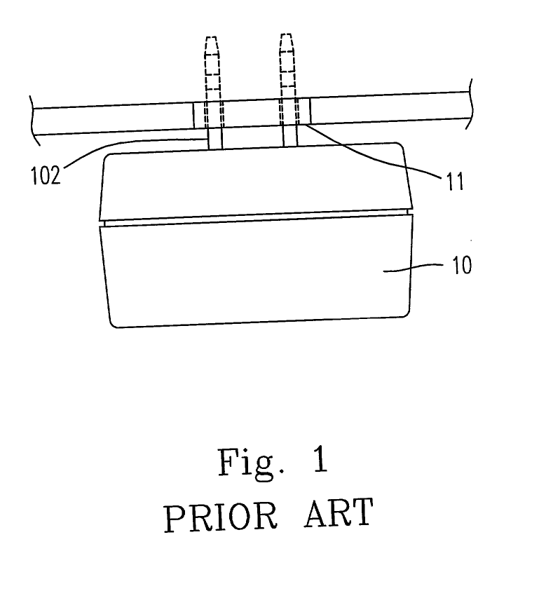

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

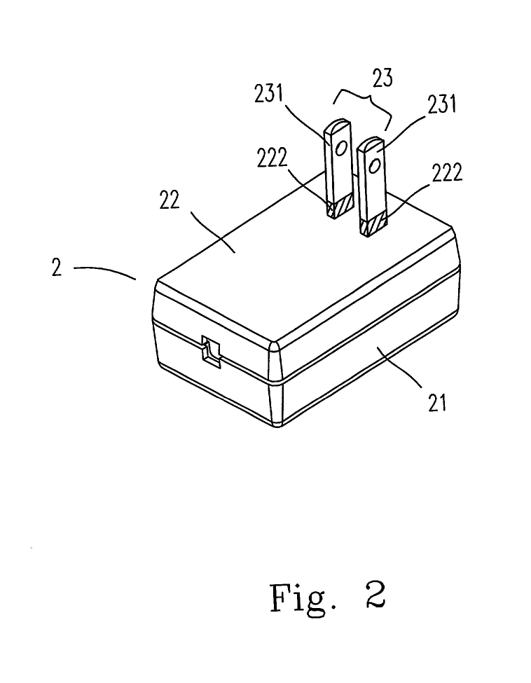

As shown in FIG. 2, a power supply apparatus 2 includes a base 21, a circuit board (not shown), a top cap 22 and a plug 23. The circuit board is used for rectifying and transforming a commercial power source into a direct current (DC). The principle is not directly related to the present invention and is well known to those skilled in the art, so that detailed description is omitted therein. The plug 23 includes at least two conductive terminals which can be column-like or flat-like pins. In the embodiment of FIG. 2, the conductive terminals are two metal pins 231. As shown in FIG. 2, two insulating rings 222 having a particular length are wrapped around the two metal pins 231 at the root section thereof, respectively, and are connected to a junction area of the metal pins 231 and the top cap 22.

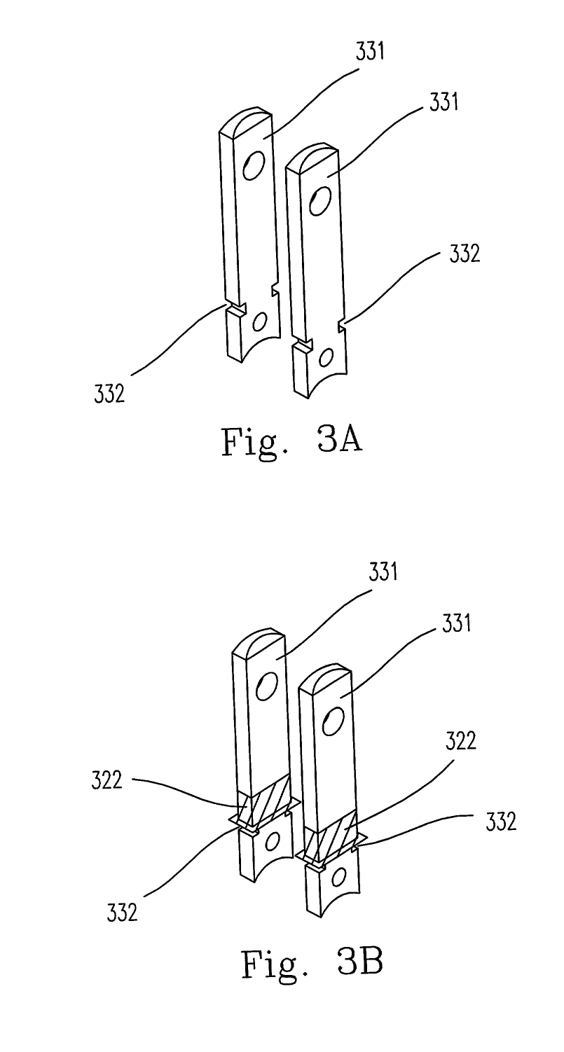

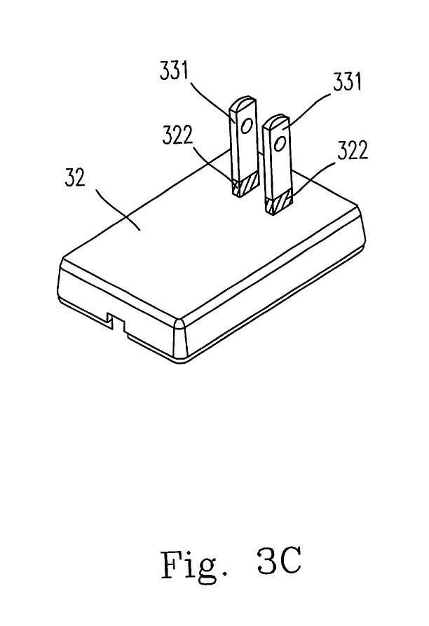

FIGS. 3A-3C are diagrams illustrating a preferred embodiment of a method for producing a protection structure applied in a power supply apparatus according to the present invention. As shown in FIG. 3A, each of two conductive terminals 331 has two gaps 332 located at the two edges thereof and close to the root section. Sequentially, as shown in FIG. 3B, two insulating rings 322 are formed at the root section of the two conductive terminals 331, respectively, by plastic molding. Finally, as shown in FIG. 3C, the bottoms of the insulating rings 322, the gaps 332 of the conductive terminals 331 and the top cap 22 are plastically molded together to form the power supply apparatus having the protection structure for the plug of the present invention.

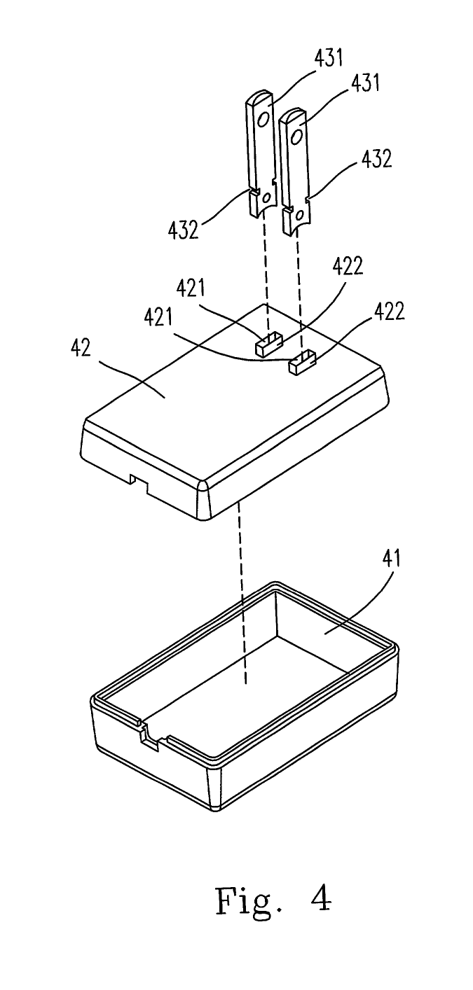

FIG. 4 is a decomposed diagram illustrating another preferred embodiment of a power supply apparatus having a protection structure for a plug according to the present invention. As shown in FIG. 4, the structure of a top cap 42, a base 41, two conductive terminals 431, two gaps 432, and two insulating rings 422 are similar to those of the above example except that the insulating ring 422 and the top cap 42 are integrally formed. Then, the conductive terminals 431 are inserted into two holes 421, respectively, and the gaps 432 of the conductive terminals 431 are used for fastening the conductive terminals 431 on the top cap 42.

Moreover, the gaps 332, 432 of the conductive terminals 331, 431 can enhance the strength of the plug to avoid the problem of declining the rigidity of the metal. The insulating rings, the top cap and the base are made of polycarbonate (PC) resin, poly-phenylene oxide (PPO) resin, nylon, polybutylene terephthalate (PBT) resin, acrylonitrile-butadiene-styrene (ABS) resin, or the combination thereof. In addition, the particular length of the insulating ring is ranged from 3 to 5 mm considering the exposed length of the metal pin when it plugs into the wall socket.

In addition, according to different specification, the plug can include two or three pins. The power supply apparatus can be an adapter or a charger.

In sum, the present invention provides a power supply apparatus having a protection structure for plug to solve the safety problems resulted from the prior art, such as the electric shock or the electric fire. In addition, the advantages of the power supply apparatus with the protection structure for plug according to the present invention also include simple production, secured operation and excellent position.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply apparatus having a protection structure for a plug comprising a case and said plug comprising at least two conductive terminals, characterized in that:
said powder supply apparatus further comprises at least two insulating rings corresponding to said conductive terminals, wherein each said insulating ring has a particular length, is surrounded each said conductive terminal and is connected to a junction area of said case and each said conductive terminal.

2. The power supply apparatus according to claim 1 wherein said power supply apparatus is one of an adapter and a charger.

3. The power supply apparatus according to claim 1 wherein said insulating rings and said case are made of a thermal plasticity material.

4. The power supply apparatus according to claim 3 wherein said thermal plasticity material is selected from a group consisting of polycarbonate (PC) resin, poly-phenylene oxide (PPO) resin, nylon, polybutylene terephthalate (PBT) resin, acrylonitrile-butadiene-styrene (ABS) resin, and a combination thereof.

5. The power supply apparatus according to claim 1 wherein said particular length is ranged from 3 to 5 mm.

6. The power supply apparatus according to claim 1 wherein each said conductive terminal has two gaps located at said junction area for fastening each said conductive terminal on said case.

7. The power supply apparatus according to claim 1 wherein said insulating rings and said case are integrally formed.

8. A power supply apparatus having a protection structure, comprising:
a plug comprising at least two conductive terminals;
a case having at least two holes for said at least two conductive terminals inserting therein;
at least two insulating rings corresponding to said conductive terminals, wherein each said insulating ring has a particular length, is surrounded each said conductive terminal at a root section and is connected to a junction area of said case and each said conductive terminal.

9. The power supply apparatus according to claim 8 wherein said power supply apparatus is one of an adapter and a charger.

10. The power supply apparatus according to claim 8 wherein said insulating rings and said case are made of a thermal plasticity material.

11. The power supply apparatus according to claim 10 wherein said thermal plasticity material is selected from a group consisting of polycarbonate (PC) resin, poly-phenylene oxide (PPO) resin, nylon, polybutylene terephthalate (PBT) resin, acrylonitrile-butadiene-styrene (ABS) resin, and a combination thereof.

12. The power supply apparatus according to claim 8 wherein said particular length is ranged from 3 to 5 mm.

13. The power supply apparatus according to claim 8 wherein each said conductive terminal has two gaps located at said junction area for fastening each said conductive terminal on said case.

14. The power supply apparatus according to claim 8 wherein said insulating rings and said case are integrally formed.
